(19) United States
(12) Patent Application Publication
(10) Pub. No.: US 2008/0072556 A1
(43) Pub. Date: Mar. 27, 2008

(54) Rotary zero-turn steer-by-wire mower

(76) Inventors: Wilfred H. Tegtmeier, Beatrice, NE (US); Deven McGhee, Beatrice, NE (US); Paul Busboom, Pickrell, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/904,250

(22) Filed: Sep. 26, 2007

Related U.S. Application Data
(60) Provisional application No. 60/847,315, filed on Sep. 26, 2006.

(51) Int. Cl. A01D 75/30; A01D 34/66

(52) U.S. Cl. 56/7; 56/14.7

(57) ABSTRACT

A rotary zero-turn steer-by-wire mower for golf courses includes a chassis, forward drive wheels mounted on axles mounted underneath the chassis and connected to an engine and transmission and swivel-mounted rear wheels mounted on the chassis. Side-by-side rear mower decks are mounted underneath the chassis with three side-by-side mounted forward mower decks mounted on a forward mower deck mounting structure extending forwards from the chassis, each of the five mower decks being independently mounted on a floating mount structure with hydraulic connections for driving the mower blades mounted therewithin. The mower unit is controlled by a steer-by-wire twin stick speed and direction control system which eliminates mechanical connection between the mower controls and steering and throttle systems, thereby reducing mechanical breakdown possibilities.

### CROSS-REFERENCE TO RELATED PATENTS

This application claims priority based on a provisional patent, specifically on the Provisional Patent Application Ser. No. 60/847,315 filed Sep. 26, 2007.

### BACKGROUND OF THE INVENTION

1. Technical Field

The present invention is directed to multi-deck mowers and, more particularly, to a rotary zero-turn steer-by-wire mower for golf courses which includes a chassis, forward drive wheels mounted on axles mounted underneath the chassis and connected to an engine and transmission, swivel-mounted rear wheels mounted on the chassis, side-by-side rear mower decks mounted underneath the chassis, three side-by-side mounted forward mower decks mounted on a forward mower deck mounting structure extending forwards from the chassis, each of the five mower decks being independently mounted on a floating mount structure with hydraulic connections for driving the mower blades mounted therewithin, and the entire mower unit is controlled by a steer-by-wire twin stick speed and direction control system which eliminates mechanical connection between the mower controls and steering and throttle systems, thereby reducing mechanical breakdown possibilities.

2. Description of the Prior Art

Gang-type mowers are commonly used for the maintenance and lawn care of golf courses, and in general, these gang-type mowers include a plurality of reel-type gangs which generally consist of a series of blades that rotate downwards over the lawn, brushing up the grass as it is cut with one blade following the next in quick succession. In general, reel-type gang mowers are used for cutting the greens of the golf course, as the reel-type gang cuts the grass cleanly and more evenly than other types of mowing devices. However, when these reel-type gang mowers are used in connection with the cutting of fairways and roughs of golf courses, they can easily become jammed or cut the grass inefficiently due to the increased thickness and length of the fairway and/or rough grass. There is therefore a need for a different type of gang mower device which can be used in connection with the cutting of fairway and rough grass.

Another problem encountered in connection with gang mowers currently available on the market is that because they are often towed behind a tractor or pushed in front of the powered vehicle, it is sometimes difficult to properly guide the gang mower for cutting of fairways and roughs. Ideally, one would use a zero-turn type of mowing device for such a purpose, but in general these mowers only include a single large rotary blade or a pair of rotary blades mounted underneath the chassis of the vehicle. This means that the cutting width provided by the zero-turn mower is relatively narrow, and in view of the fact that a golf course includes acre upon acre of grass which needs to be cut, a mower of limited cutting width is virtually useless. There is therefore a need for a zero-turn type of mowing device which incorporates the gang mower configuration in order to provide a wide cutting swath while also providing an easily controllable and accurate cutting device.

Finally, another problem encountered with mowing devices currently found in the prior art is that they rely on mechanical connections between the steering and throttle control mechanisms and the steering and throttle mechanisms themselves to enable the operator to control the mowing device. A significant problem in the prior art, however, is that such mechanical linkages are prone to failure and performance degradation over time, as the linkages often become laden with debris and grass cuttings which are kicked up through operation of the mower. If these materials are not periodically cleaned from the control linkages, operation of the mowing device will become progressively more difficult and eventually will fail. There is therefore a need for an improved control system which generally eliminates the mechanical linkages between the control devices and the steering and throttle mechanisms themselves.

Therefore, an object of the present invention is to provide an improved rotary zero-turn steer-by-wire mower.

Another object of the present invention is to provide an improved rotary zero-turn steer-by-wire mower which includes no mechanical steering and control connections between the left and right control levers and the engine and the transmission.

Another object of the present invention is to provide an improved rotary zero-turn steer-by-wire mower which includes a computer control module operative to interpret the positioning of the left and right control levers and then forward commands via electronic signals to the engine, transmission and the left and right forward drive wheels thereby reducing the possibility of mechanical breakdowns in the mower.

Another object of the present invention is to provide an improved rotary zero-turn steer-by-wire mower which includes five mower decks in an offset arrangement in which the left and right forward mower decks are mounted outwards and spaced from the middle forward mower deck and left and right rear mower decks which cut the uncut grass between the forward decks to make a broad cutting swath for the mower of the present invention.

Finally, an object of the present invention is to provide improved rotary zero-turn steer-by-wire mower which is relatively simple and durable in construction and is safe, efficient and effective in use.

### SUMMARY OF THE INVENTION

The present invention provides a rotary zero-turn steer-by-wire mower which includes a chassis, an engine and a transmission mounted on the chassis, forward drive wheels rotatably mounted on the chassis and rear wheels rotatably and swivelably mounted on the chassis. At least two mower decks are mounted underneath the chassis and are connected to the engine, and a steer-by-wire twin stick speed and direction control system controls the operation of the mower, the system including an operator control device mounted on the chassis with a computer control module operatively connected to and interposed between the left and right operator control levers and the engine and the transmission. The computer control module is operative to interpret the relative positions of the left and right control levers and forward commands to the engine and the transmission to control rotation of the forward drive wheels free of mechanical connections between the operator control device and the engine and the transmission thereby reducing mechanical breakdown possibilities.

The present invention thus provides numerous advantages over the prior art. For example, because the present invention does not include mechanical linkages between the steering and drive controls and the engine and transmission, there are fewer opportunities for mechanical breakdowns to occur and therefore the mower will have less down time for repairs than other mowers found in the prior art. Furthermore, because the present invention includes a programmable computer control module which controls the mower decks and the steering and drive controls, modifications in operational characteristics are more easily performed merely by changing the programming of the control module rather than making multiple modifications to mechanical connections and linkages. Finally, because the present invention is a zero-turn design, mowing of even hard-to-reach areas is facilitated, which renders the present invention a substantial improvement over the prior art.

### BRIEF DESCRIPTION OF THE DRAWINGS

FIG. 1 is a perspective view of the rotary zero-turn steer-by-wire mower of the present invention;

FIG. 2 is a side elevational view of the present invention;

FIG. 3 is a detailed perspective view of one of the rotary mower decks of the present invention;

FIG. 4 is a schematic view of the steer-by-wire control system utilized by the present invention.

### DESCRIPTION OF THE PREFERRED EMBODIMENT

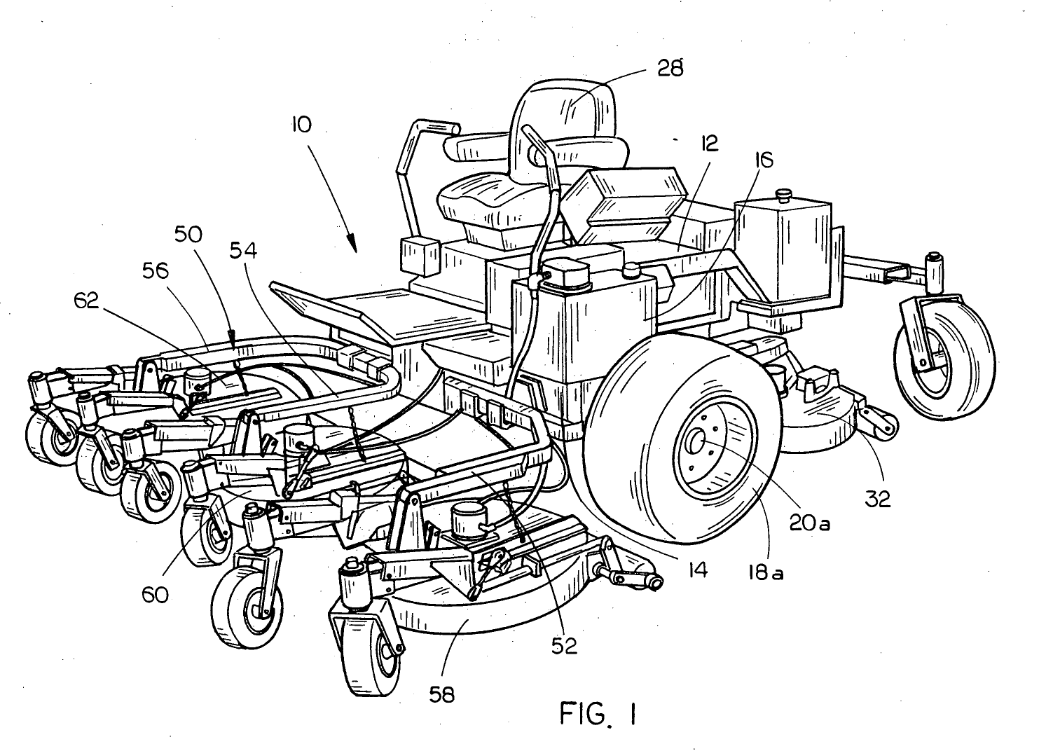

The rotary zero-turn steer-by-wire mower 10 of the present invention is shown best in FIGS. 1-4 as including a mower body 12 which includes an engine 14, preferably diesel, which is mounted on the mower body 12 to provide power for the entire mower system of the present invention. In the preferred embodiment, the engine 14 would be an approximately sixty-seven horsepower (67 HP) unit and would be coupled to a single variable displacement pressure compensated hydraulic pump 16 that provides pressure and flow of hydraulic fluid to the various hydraulic functions of the mower 10 of the present invention. The engine 14 is connected via a gear box or transmission to the drive wheels 18a and 18b which are mounted on a pair of axles 20a and 20b mounted on the underside of mower body 12, as shown best in FIG. 1. A pair of rear wheel mounting structures 22a and 22b are mounted on the rear of the mower body 12, with a pair of rear wheels 24a and 24b being provided to support the rear of the mower body 12, one of the rear wheels 24a and 24b being mounted on each of the rear wheel mounting structures 22a and 22b. It is further preferred that the rear wheels 24a and 24b be mounted on swivels or casters 26a and 26b mounted on the rear wheel mounting structures 22a and 22b such that the rear wheels 24a and 24b may be rotated through three hundred sixty degrees (360°) as will be described later herein. Finally, mounted atop the mower body 12 is an operator's seat 28 which may be of any appropriate size and shape, although it is preferred that the operator's seat 28 be mounted on a seat suspension device (not shown) which will increase the comfort level for the operator seated in the operator's seat 28, although the inclusion of such a device is not necessary to the functionality of the present invention.

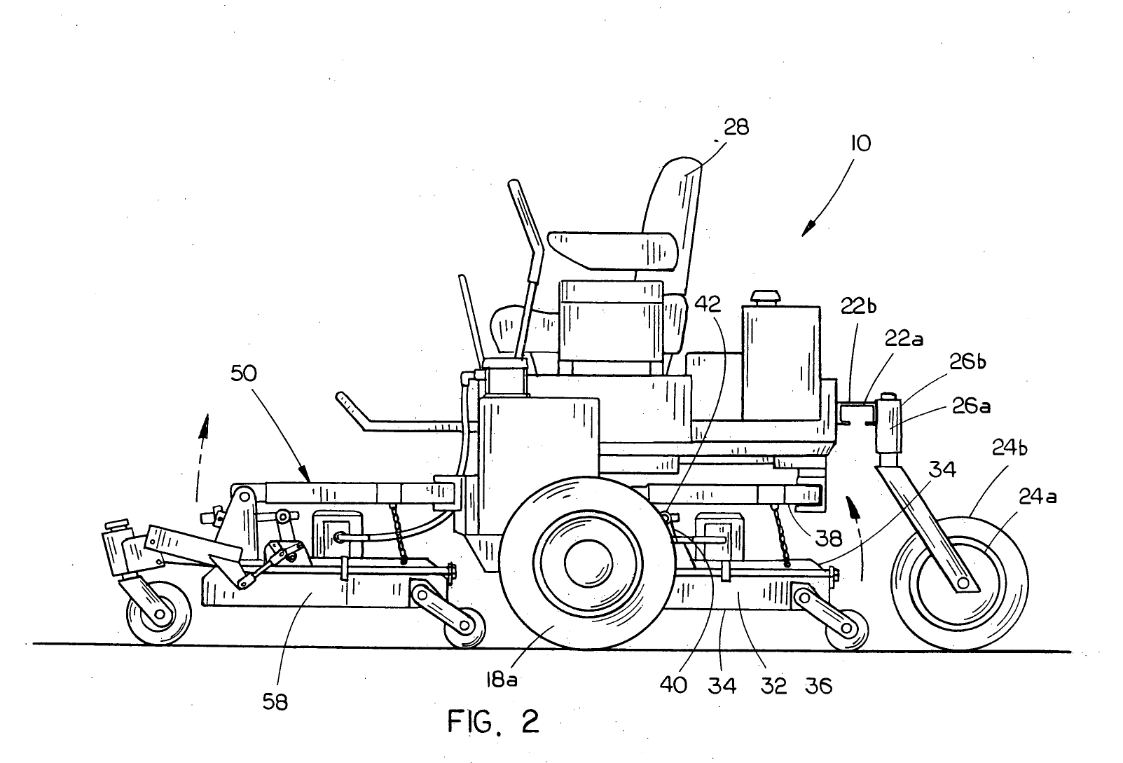

Mounted on the underside of the mower body 12 are a pair of independently mounted rear mower decks 32 and 34 which are mounted in a side-by-side configuration underneath the mower body 12, as shown in FIGS. 1 and 2. In the preferred embodiment, each of the rear mower decks 32 and 34 would be mounted on an independent rear deck mounting on 36 and 38 which is pivotally mounted on the mower body 12 and is held in place by an hydraulic cylinder 40 and 42 which is operative to raise and lower the left and right rear mower deck arms 36 and 38 and hence the left and right rear mower decks 32 and 34 which are mounted on the end of the respective left and right rear mower deck arm 36 and 38.

A forward mower deck mounting structure 50 is mounted on and extends forwards from the mower body 12, as shown in FIG. 1 and 2, and would preferably include left, middle, and right forward mower deck mounting arms 52, 54 and 56 at the outer ends of which are pivotably mounted the left, middle, and right forward mower decks 58, 60, and 62. Each of the left, middle, and right forward mower deck mounting arms 52, 54 and 56 would preferably be pivotably mounted on the mower body 12 to permit raising and lowering of the forward mower decks 58, 60 and 62, which will be performed by one or more hydraulic cylinders which will be operative to lift each of the forward mower decks 58, 60 and 62 to a transport position and likewise lower the decks into their cutting position, as shown in FIG. 1. Alternatively, it may be preferable to raise and lower the forward mower decks 58, 60 and 62 as a single unit, and in this case, the left, middle, and right forward mower deck mounting arms 52, 54 and 56 would then be mounted on a single pivoting hinge mount mounted on the front of the mower body 12.

An important feature of the mounting of the left, middle, and right forward mower decks 58, 60 and 62 and left and right rear mower decks 32 and 34 is that they would be aligned such that an optimum cut width is provided which leaves no uncut grass between the decks. The preferred arrangement for the five mower decks than is an offset arrangement in which the left and right forward mower decks 58 and 62 are mounted outwards and spaced from the middle forward mower deck 60 such that the mower 10, when moving forward, will cut three swaths in the grass via the left, middle and right forward mower decks 58, 60 and 62. The uncut grass which remains between the left and middle and middle and right forward mower decks 58, 60 and 62 is then cut by the left and right rear mower decks 32 and 34, and therefore the total cut width of the present invention extends from the outer edges of the left forward mower deck 58 to the outer edge of the right forward mower deck 62 with no uncut grass being found there between. In the preferred embodiment, this results in approximately a one hundred eight inch (108″) wide swath of cut grass, although this is dependent on the size of the mower decks themselves and the desired spacing between the mower decks, which is not critical to the functionality of the present invention so long as the five mower decks cooperate in quickly and efficiently cutting the wide cut in the grass.

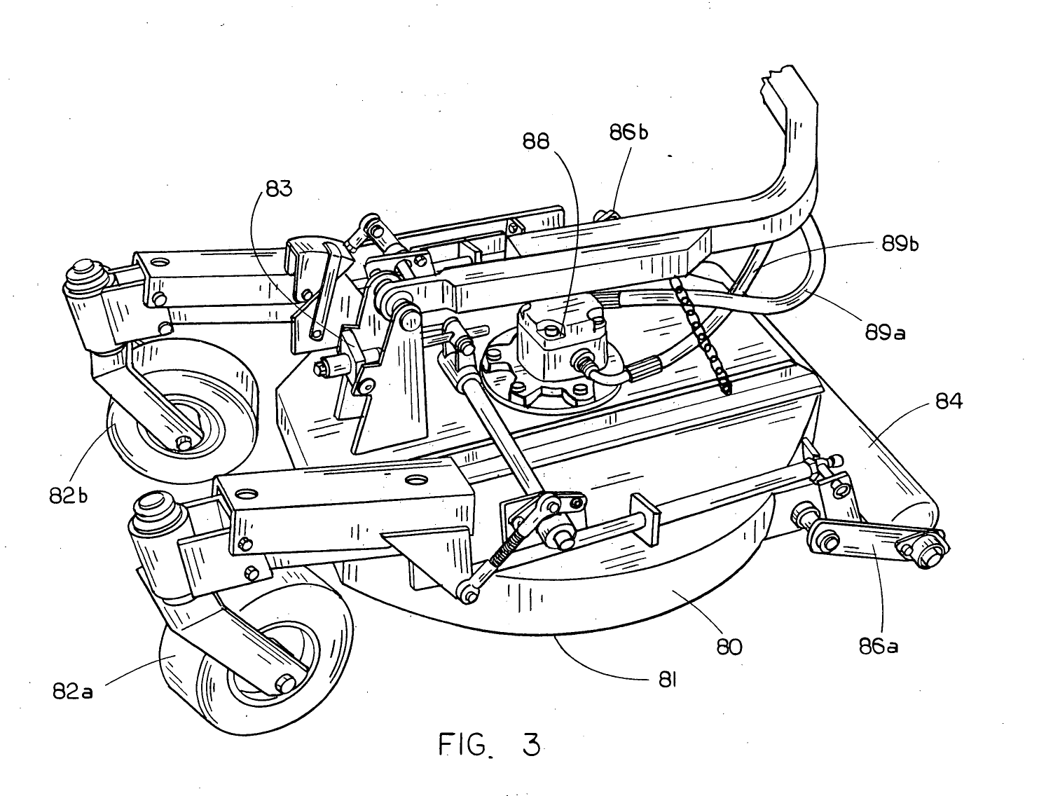

As each of the left and right rear mower decks 32 and 34 and left, middle and right forward mower decks 58, 60 and 62 are generally identical to one another, the following description of left forward mower deck 58 should be understood to apply generally to each and every one of the elements of the other four mower decks. Specifically, as shown best in FIG. 3, left forward mower deck 58 would include a generally cylindrical mower deck 80 underneath which is rotatably mounted a cutting blade 82 which, in the preferred embodiment, would have a width of approximately twenty to thirty inches and would also preferably be a mulching-type blade in order to provide the proper mulching for grass being cut by the present invention. Mounted on and extending forwards from the mower deck are a pair of front caster wheels 82a and 82b and mounted on the back of the mower deck 80 is a rear roller 84 which engages the ground surface over which the mower deck 80 is traveling. The rear roller 84 is pivotally mounted on the mower deck 80 by arms 86a and 86b such that the rear roller 84 may be pivoted upwards or downwards relative to the mower deck 80 along with the height of the pair of front caster wheels 82a and 82b via a mechanical linkage height adjustment mechanism 83 to set the cutting height for the mower deck 80, the rear roller 84 also operative to prevent turf scuffing and achieve turf stripping, both of which are desirable features of such a mowing device. Finally, rotation of the mower blade 81 is achieved via an hydraulic drive mechanism 88 which is connected via feed and return hoses 89a and 89b to the hydraulic pump 16 connected to engine 14, and as hydraulic fluid is circulated through the feed and return hoses 89a and 89b, the hydraulic drive mechanism 88 rotates the mower blade 81 at a high rate of revolutions to cut the grass passing there underneath.

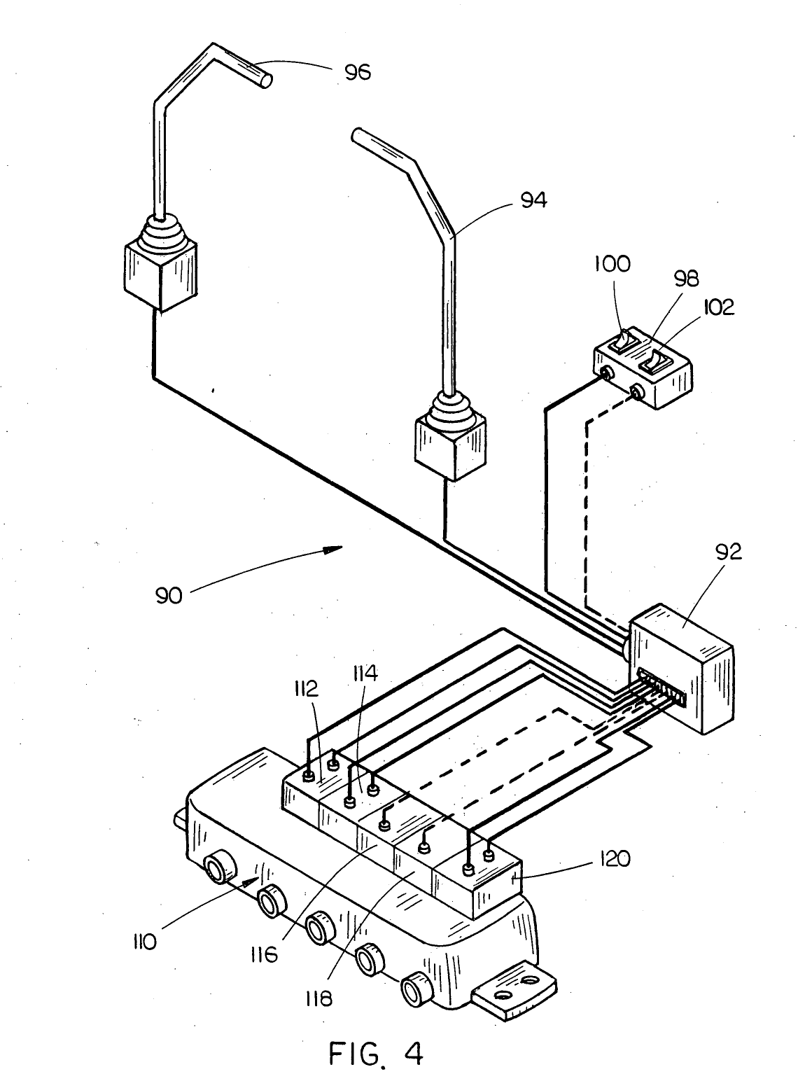

One of the key features of the present invention, however, which is shown best in FIG. 4, is the steer-by-wire system which is used for controlling speed and direction of the rotary zero-turn steer-by-wire mower 10 of the present invention. Specifically, the steer-by-wire system 90 would include a computer control module 92 which serves as the interface between the left and right operator control levers 94 and 96, the operator control panel 98 which includes deck engagement switch 100 and deck lift switch 102 and the various hydraulic valves 110 which include the left drive motor valve 112, right drive motor valve 114, forward three-deck motor valve 116, rear two-deck motor valve 118, and two-deck boom lift valve 120. In operation, the steer-by-wire system 90 would be used as follows. The left and right operator control levers 94 and 96 would be used to respectively control the left drive motor valve 112 and right drive motor valve 114 to drive the drive wheels 18a and 18b mounted on the pair of axles 20a and 20b, such that the drive wheels 18a and 18b are independently operable to permit operation and control of the present invention as zero-turn mowing device. The computer control module 92 is programmed to interpret the relative position of the left and right control levers 94 and 96 via sensors and forward appropriate commands to the left and right drive motor valves 112 and 114 to open or close the valves in conjunction with the positioning of the left and right operator control levers 94 and 96. For example, when both levers are pushed forwards, the computer control module 92 engages the left and right drive motor valves 112 and 114 to drive the drive wheels 18a and 18b to move the rotary zero-turn steer-by-wire mower 10 of the present invention forwards at a rate of speed proportional to the amount of forward movement of the left and right operator control levers 94 and 96. Likewise, when both levers are pulled rearwards, the computer control module 92 engages the left and right drive motor valves 112 and 114 to drive the drive wheels 18a and 18b to move the rotary zero-turn steer-by-wire mower 10 of the present invention rearwards at a rate of speed proportional to the amount of rearward movement of the left and right operator control levers 94 and 96. Various combinations of positions of the left and right operator control levers 94 and 96 will result in steering and turning of the mower 10, and such driving procedures are well-known to operators of mower vehicles. However, the steer-by-wire control system 90 is not known in the prior art, and it is this improvement which is unique as compared to other mowers found in the prior art.

One of the key reasons for including the steer-by-wire control system 90 is to facilitate the eventual implementation of radio frequency guidance (RFG) or unmanned vehicle (UV) control during operation of the mower 10. Specifically, RFG or UV control would serve to remove the human operator from potentially unsafe operating environments, such as locations with poor air quality, extreme grade slopes which need to be mowed and other such unsafe grass cutting situations. The steer-by-wire control system 90 may be connected to a remote control device which bypasses the left and right operator control levers 94 and 96 and simply commands the operations of the computer control module 92 to control operation of the mower 10, the controls for which would be provided by any appropriate remote control device currently available, modified for use with the present invention. It should be further noted that the specific operational characteristics of such a remote control system would generally be determined through experimentation, and therefore further discussion of the specific details of such a system will not be entered into in this disclosure.

It is to be understood that numerous additions, substitutions, and modifications may be made to the mower 10 of the present invention which fall within the intended broad scope of the above description. For example, the size, shape and construction materials used in connection with the various elements of the present invention may be modified or changed so long as the functionality of the invention is neither degraded nor destroyed. Also, it should be noted that although the steer-by-wire control system 90 is described as including certain hydraulic valves operative to control various elements of the mower 10, the steer-by-wire control system 90 may include further control elements for other operative devices of the mower 10 so long as the critical features of controlling speed and direction of the mower 10 are maintained. Finally, it should be noted that the mower 10 of the present invention may include more or fewer mower decks depending on the size of the grass cut swath that is to be produced.

There has therefore been shown and described a rotary zero-turn steer-by-wire mower 10 which accomplishes at least all of its intended purposes.

I claim:

1. A rotary zero-turn steer-by-wire mower comprises:
a chassis;
engine means and transmission means mounted on said chassis;
forward drive wheels rotatably mounted on said chassis;
rear wheels rotatably and swivelably mounted on said chassis;
at least one mower deck mounted underneath said chassis and connected to said engine means;
a steer-by-wire speed and direction control system including;
operator control means mounted on said chassis;
a computer control module operatively connected to and interposed between said operator control means and said engine means and said transmission means;
said computer control module operative to interpret the relative positioning of said operator control means and forward commands to said engine means and said transmission means to control rotation of said forward drive wheels free of mechanical connections between said operator control means and said engine means and said transmission means thereby reducing mechanical breakdown possibilities.

2. The rotary zero-turn steer-by-wire mower of claim 1 wherein said at least one mower deck further comprises three side-by-side mounted forward mower decks mounted on a forward mower deck mounting structure extending forwards from the chassis, and two rear side-by-side mower decks mounted underneath said chassis, each of said three forward and two rearward mower decks being independently mounted on a floating mount structure with hydraulic connections for driving the mower blades mounted therewithin.

3. The rotary zero-turn steer-by-wire mower of claim 1 wherein said operator control means comprises left and right operator control levers operative to control said transmission and said engine to drive said forward drive wheels whereby said forward drive wheels are independently operable to permit operation and control of said mower.

4. The rotary zero-turn steer-by-wire mower of claim 3 wherein said computer control module is programmed to interpret the relative position of said left and right control levers via sensors and forward appropriate commands to said transmission and said engine to drive said forward drive wheels in conjunction with the detected positioning of said left and right operator control levers.

5. The rotary zero-turn steer-by-wire mower of claim 1 wherein said transmission means comprises a left drive motor valve and a right drive motor valve operative to drive said forward drive wheels such that said forward drive wheels are independently operable to permit operation and control of the mower as zero-turn mower.

6. The rotary zero-turn steer-by-wire mower of claim 1 further comprising a remote control device operative to bypass said operator control means to command the various operations of said computer control module thereby controlling operation of said mower.

7. A rotary zero-turn steer-by-wire mower comprises: a chassis;
engine means and transmission means mounted on said chassis;
forward drive wheels rotatably mounted on said chassis;
rear wheels rotatably and swivelably mounted on said chassis;
at least one mower deck mounted underneath said chassis and connected to said engine means;
a steer-by-wire speed and direction control system including;
left and right operator control levers mounted on said chassis, said left and right operator control levers operative to control said transmission and said engine to drive said forward drive wheels whereby said forward drive wheels are independently operable to permit operation and control of said mower;
a computer control module operatively connected to and interposed between said left and right operator control levers and said engine means and said transmission means;
said computer control module operative to interpret the relative positioning of said left and right operator control levers and forward commands to said engine means and said transmission means to control rotation of said forward drive wheels free of mechanical connections between said left and right operator control levers and said engine means and said transmission means thereby reducing mechanical breakdown possibilities.

8. The rotary zero-turn steer-by-wire mower of claim 7 wherein said at least one mower deck further comprises three side-by-side mounted forward mower decks mounted on a forward mower deck mounting structure extending forwards from the chassis, and two rear side-by-side mower decks mounted underneath said chassis, each of said three forward and two rearward mower decks being independently mounted on a floating mount structure with hydraulic connections for driving the mower blades mounted therewithin.

9. The rotary zero-turn steer-by-wire mower of claim 8 wherein said computer control module is programmed to interpret the relative position of said left and right control levers via sensors and forward appropriate commands to said transmission and said engine to drive said forward drive wheels in conjunction with the detected positioning of said left and right operator control levers.

10. The rotary zero-turn steer-by-wire mower of claim 7 wherein said transmission means comprises a left drive motor valve and a right drive motor valve operative to drive said forward drive wheels such that said forward drive wheels are independently operable to permit operation and control of the mower as zero-turn mower.

11. The rotary zero-turn steer-by-wire mower of claim 7 further comprising a remote control device operative to bypass said operator control means to command the various operations of said computer control module thereby controlling operation of said mower.
